(19) United States
(12) Patent Application Publication
(10) Pub. No.: US 2017/0052923 A1
(43) Pub. Date: Feb. 23, 2017

(54) APPARATUSES AND METHODS FOR BALANCED TRANSMITTAL OF DATA

(71) Applicant: Intel Corporation, Santa Clara, CA (US)

(72) Inventor: Min Wang, Santa Clara, CA (US)

(21) Appl. No.: 14/830,612

(22) Filed: Aug. 19, 2015

(51) Int. Cl. G06F 13/42; G06F 13/16

(52) U.S. Cl. CPC G06F 13/42; G06F 13/16

(57) ABSTRACT

Methods and apparatuses relating to balanced transmittal of data are described. In one embodiment, an apparatus includes an encoder to encode input data into at least one data group with each data group having an equal number of a first level signal and a second, lower level signal to transmit the at least one data group over single conductors in parallel, and a decoder to decode the at least one data group into output data. In another embodiment, a method includes encoding input data with an encoder into at least one data group with each data group having an equal number of a first level signal and a second, lower level signal to transmit the at least one data group over single conductors in parallel, and decoding the at least one data group into output data with a decoder.

### TECHNICAL FIELD

The disclosure relates generally to electronics, and, more specifically, an embodiment of the disclosure relates to an encoder and decoder for balanced transmittal of data.

### BACKGROUND

Electronics (e.g., computer systems) generally employ one or more electrical connections to facilitate the transmittal of data (e.g., communication) between system components, such as between a processor and memory. Electrical connections may also be used to facilitate the transmittal of data between on-die and/or off-die components, such as input and output (I/O) devices, peripherals, etc.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a hardware system having an encoder and a decoder according to embodiments of the disclosure.

FIG. 2 illustrates a schematic diagram of a two conductors per group encoding according to embodiments of the disclosure.

FIG. 3 illustrates a schematic diagram of a four conductors per group encoding according to embodiments of the disclosure.

FIG. 4 illustrates a schematic diagram of a six conductors per group encoding according to embodiments of the disclosure.

FIG. 5 illustrates a schematic diagram of a twelve conductors per group encoding according to embodiments of the disclosure.

FIG. 6 illustrates a block diagram of a system according to embodiments of the disclosure.

FIG. 7 illustrates a flow diagram according to embodiments of the disclosure.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Electronics (e.g., computer systems) generally employ one or more electrical connections (e.g., an interconnect or bus) to facilitate the transmittal of data (e.g., communication) between components, such as, but not limited to, between a processor and (e.g., random-access) memory, a first processor and a second processor, a first semiconductor chip and a second semiconductor chip (e.g., chip-to-chip), a processor (e.g., a central processing unit (CPU)) and an application-specific integrated circuit (ASIC), a processor (e.g., a central processing unit (CPU)) and a field-programmable gate array (FPGA), a processor and a peripheral, etc. Electrical connections may also be used to facilitate the transmittal of data between on-die and/or off-die components, such as input and output (I/O) devices, peripherals, etc. Certain electrical connections include parallel conductors (e.g., parallel wires, trenches, vias, or other electrically conductive paths). One embodiment of an electrical connection is a multiple conductor parallel bus, for example, where the conductors allow parallel (e.g., concurrent) transmittal of data thereon. The term electrical connection (e.g., interconnect or bus) may generally refer to one or more separate physical connections, communication lines and/or interfaces, shared connections, and/or point-to-point connections, which may be connected by appropriate bridges, adapters, and/or controllers.

However, in certain embodiments a conductor of a bundle of conductors of an electrical connection operating in parallel may experience interference, e.g., noise, caused by one or more of the other conductors. Interference may be electromagnetic interference, for example, crosstalk. Crosstalk may generally refer to the inductive coupling between two or more adjacent conductors (e.g., lines, lanes, or channels), for example, where a data signal from one or more conductors interferes with the data signal on a nearby conductor, for example, that changes the signal (e.g., voltage) on the conductor sufficiently to cause an error. Interference may be from a current fluctuation in power delivery, for example, the change in current (i) over a change in time (t), which may be referred to as (di/dt) or simultaneous switching noise. In certain embodiments, current fluctuations associated with rapid changes in power (e.g., current) levels may cause an error (e.g., an incorrect bit value). In one embodiment, the encoder, transmitter(s), receiver(s), and/or decoder are powered in the same power domain (e.g., the same local area power grid).

Certain embodiments may utilize differential signaling. Differential signaling may include having two conductors (e.g., a differential pair) for each signal to be transmitted, for example, such that for each signal the transmitting component sends on a first conductor, a compliment of the signal is sent on a second conductor (e.g., such that the two components are 180 degrees out of phase with each other), e.g., having a coding efficiency of 0.5 bits per conductor (1 bit/2 conductors). Doubling the conductors used (e.g., pin count) may cause increased die and/or system size and larger routing real estate on a die and/or system.

In contrast with differential signaling, single ended signaling transmits data over a single conductor. For example, with a first level signal (e.g., voltage or current) representing one of a logic (binary) value of zero and one and a second, lower level signal representing the other of the zero and the one. In one embodiment, only two levels of signals are utilized on each conductor to represent data, which may be generally referred to as two-level signaling. Each component of a signal may be transitioned between two particular voltages (e.g., from a power supply or amplifier) that represent logical (e.g., digital) values of zero and one. In one embodiment, each (e.g., first and second level) signal to be transmitted has its own conductor. Although not depicted, a data buffer or buffers may be utilized herein.

Certain embodiments disclosed herein include hardware apparatuses (e.g., a hardware encoder and/or a hardware decoder) and methods to encode (e.g., convert) input data (e.g., with an encoder) into at least one data group with each data group having an equal number of a first level signal and a second, lower level signal to transmit the at least one data group (e.g., over single conductors in parallel), and/or decode the at least one data group into output data (e.g., with a decoder). For example, each group has an even number of signals therein. A set of groups may transmit the entire data input. Certain embodiments herein provide a balanced data coding scheme (e.g., for parallel conductors, including, but not limited to a bus), for example, to maximize the signaling bandwidth per conductor.

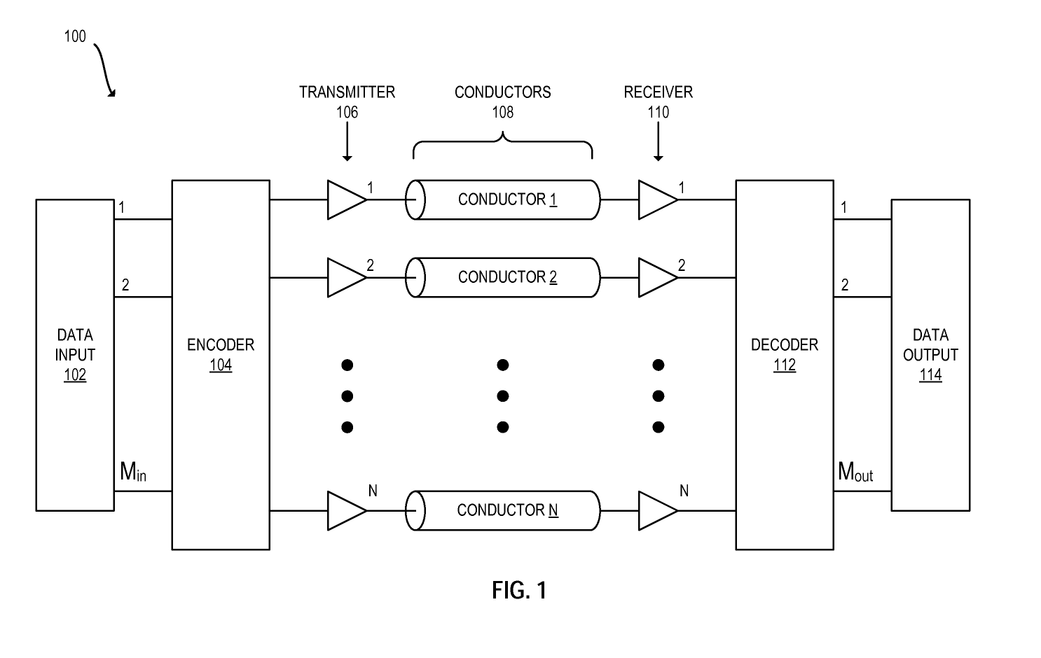

FIG. 1 illustrates a hardware system 100 having an encoder 104 and a decoder 112 according to embodiments of the disclosure. Data input is provided at 102 and data output at 114 (which may be the same format or a different format from the data input at 102). For example, a first computing component (e.g., a processor) may provide the data input at 102 and a second computing component (e.g., a memory) may receive the data output at 114, e.g., as a control signal. Data input at 102 and/or data output at 114 may include multiple discrete elements (e.g., each element being a bit). The number of discrete elements may be any number, e.g., represented as Mᵢₙ total number of input elements and Mₒᵤₜ total number of output elements in FIG. 1. In one embodiment, Mᵢₙ is equal to Mₒᵤₜ. In one embodiment, Mᵢₙ is different than Mₒᵤₜ. Encoder and/or decoder may be integrated into a hardware component (e.g., processor, memory, network resources, etc.).

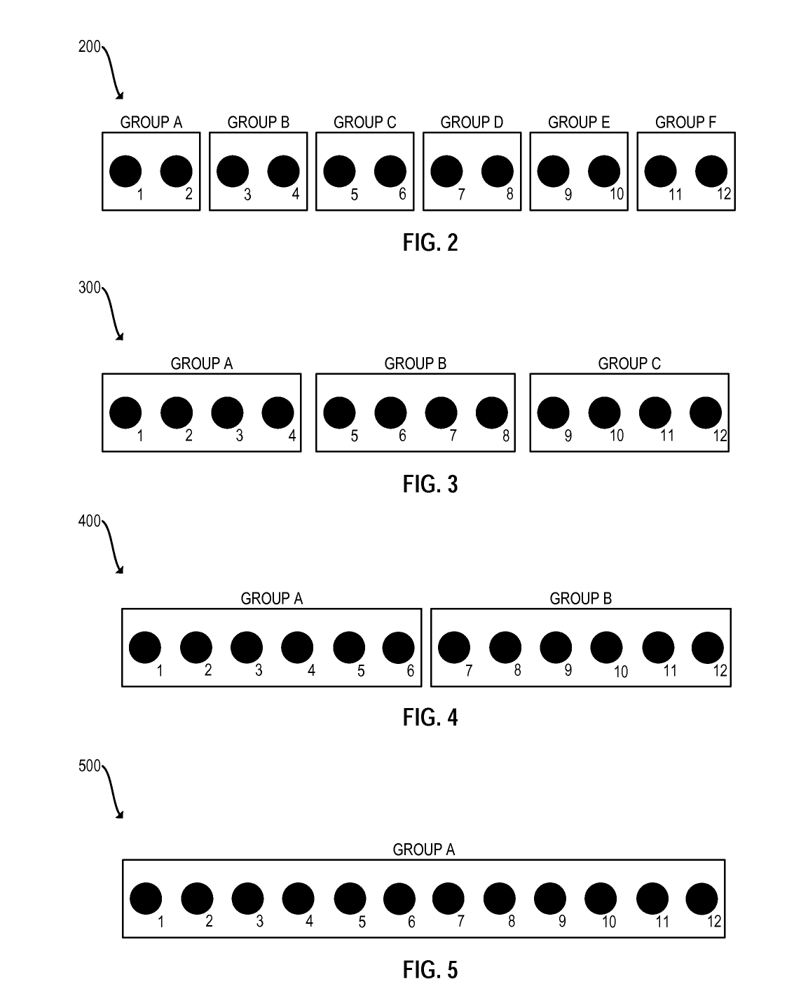

Encoder 104 may take the data input at 102 (e.g., which in one embodiment may be a single or multiple bits or bytes of data) and covert the data input at 102 into at least one data group with each data group having an equal number of a first level signal and a second, lower level signal, e.g., with examples discussed below in reference to FIGS. 2-5. In one embodiment, the first level signal is a positive voltage and the second, lower level signal is a negative voltage. The positive voltage and the negative voltage may be equal and opposite voltages, for example, according to a non-return to zero (NRZ) signaling scheme, e.g., with no neutral or rest voltages. In one embodiment, the first level signal is a positive voltage and the second, lower level signal is zero or about zero volts, e.g., according to a return to zero (RZ) signaling scheme.

The data group(s) from the encoder 104 may be output to a decoder 112, for example, over single conductors with transmission in parallel, e.g., as single ended signaling. As depicted in FIG. 1, the data group(s) from the encoder 104 are sent to the transmitter 106 to transmit the signals of each data group across the conductors 108 to a receiver 110. FIG. 1 depicts each single conductor (e.g., conductor 1 through conductor N, with N being the total number of signals to be transmitted) having a transmitter on a first end and a receiver on a second, opposing end. In one embodiment, a single transmitter and/or receiver may be utilized for a subset or all of the conductors 108. In one embodiment, a transmitter is part of an encoder. In one embodiment, a receiver is part of a decoder. In one embodiment, a transmitter is an amplifier or other driver. In one embodiment, a receiver is a sensor detecting a (e.g., voltage) value and providing an according output. In one embodiment, each component of a hardware system includes a decoder and an encoder, for example, in a decoder and encoder unit (DEU).

The receiver 110 may output the received signals of the data group(s) to the decoder, e.g., to convert the data group(s) back into the form of the data input at 102. In one embodiment, the transmitter and/or receiver may include a ground connection (not depicted), for example, where binary digits are represented as two different voltage (or current) levels on a single wire and the transmitter and/or receiver may include a built-in or external reference voltage (or current) to compare the received signal against to determine the binary value. In one embodiment, if there are N signals to transmit, a system may include N+1 conductors, e.g., with one conductor for each signal and the plus one being the common ground. Encoding and/or decoding according to this disclosure may be achieved with hardware, software, and/or firmware.

In one embodiment, an encoder is a hardware component (e.g., a finite state machine, a linear feedback shift register, or a mapping table) that includes a plurality of (e.g., digital) inputs for receiving (e.g., digital) data from an electronic component. The output of an encoder may be connected (e.g., electrically coupled) to a plurality of transmitters, e.g., each of which receives a signal from the encoder and transmits a corresponding voltage (or current) signal on its respective conductor (e.g., signal line). The encoder may encode the input data for balanced transmittal over the conductors (e.g., bus). The conductors may include receivers coupled to each of the respective conductors. Each receiver may receive the (e.g., analog) signal transmitted by a respective transmitter and may provide an input signal to a decoder. A decoder may decode the data transmitted over the conductors (e.g., bus) and transmit (e.g., digital) output data to a receiving electronic component. In one embodiment, each decoder of a plurality of decoders used is paired with a respective encoder. In one embodiment, a decoder is a hardware component (e.g., a finite state machine, a linear feedback shift register, or a mapping table) that includes a plurality of (e.g., digital) outputs for sending (e.g., digital) data to an electronic component.

In one embodiment, a decoder and/or encoder may switch between a first mode to encode input data and/or decode output data according to this disclosure and a second mode, for example, without encoding input data and/or decoding output data according to this disclosure (e.g., data may pass through an encoder without being encoded and/or pass through a decoder without being decoded in the second mode).

Turning now to FIGS. 2-5, examples of encoding (e.g., converting) input data into at least one data group with each data group having an equal number of a first level signal and a second, lower level signal is discussed, for example, where all groups have an equal number of logical ones and logical zeros within each group, e.g., at all transmission and/or read times. Although twelve signals (e.g., one for each conductor 1-12 of a twelve conductor electrical connection) are depicted, any number of signals and/or conductors may be utilized. The number of groups may be given by the total number of conductors (e.g., 12 in FIGS. 2-5) divided by the number of conductors in each group. In one embodiment, the total number of conductors divided by the number of conductors in each group does not produce a remainder (e.g., having a modulo of zero).

FIG. 2 illustrates a schematic diagram of a two conductors per group encoding 200 according to embodiments of the disclosure. In this embodiment, encoding produces six groups A-F of two conductors per group. This embodiment provides for 64 unique code words (e.g., data elements that may be represented by the different combinations of balanced signals that are to be transmitted across the conductors). In this encoding, each group may have a single logical one and a single logical zero, for example, (i) a logical one for conductor 1 and a logical zero for conductor 2 in group A and (ii) a logical zero for conductor 1 and a logical one for conductor 2 in group A in FIG. 2. Thus each group here has two combinations of signals and as there are 6 groups, 2(combinations per group)^{6(groups)}=64 code words (e.g., unique combinations). The equivalent number of conductors for a parallel electrical connection to transmit 64 code words without the encoding disclosed herein is log₂ 64 (code words)=6 conductors (e.g., pins). Thus the conductor (e.g., pin) efficiency is the number of conductors for a parallel electrical connection without encoding (6) divided by the number of pins used with the encoding of this embodiment (12), i.e.,

$$\frac{6}{12} = 0.5$$

conductor efficiency. This data is also shown in Table 1 below.

FIG. 3 illustrates a schematic diagram of a four conductors per group encoding 300 according to embodiments of the disclosure. In this embodiment, encoding produces three groups A-C of four conductors per group. This embodiment provides for 216 unique code words (e.g., data elements that may be represented by the different combinations of balanced signals that are to be transmitted across the conductors). In this encoding, each group may have six different balanced combinations, i.e., 1100, 1010, 1001, 0101, 0110, and 0011, and as there are 3 groups, 6³=216 code words (e.g., unique combinations). The equivalent number of conductors for a parallel electrical connection to transmit 216 code words without the encoding disclosed herein is log₂ 216=7.8 conductors (e.g., pins). Thus the conductor (e.g., pin) efficiency is the number of conductors for a parallel electrical connection without encoding (7.8) divided by the number of pins used with the encoding of this embodiment (12), i.e.,

$$\frac{7.8}{12} = 0.65$$

conductor efficiency. This data is also shown in Table 1 below.

FIG. 4 illustrates a schematic diagram of a six conductors per group encoding 400 according to embodiments of the disclosure. In this embodiment, encoding produces two groups A-B of six conductors per group. This embodiment provides for 400 unique code words (e.g., data elements that may be represented by the different combinations of balanced signals that are to be transmitted across the conductors). In this encoding, each group may have twenty different balanced combinations and as there are 2 groups, 20²=400 code words (e.g., unique combinations). The equivalent number of conductors for a parallel electrical connection to transmit 400 code words without the encoding disclosed herein is log₂ 400=8.64 conductors (e.g., pins). Thus the conductor (e.g., pin) efficiency is the number of conductors for a parallel electrical connection without encoding (8.64) divided by the number of pins used with the encoding of this embodiment (12), i.e.,

$$\frac{8.64}{12} = 0.72$$

conductor efficiency. This data is also shown in Table 1 below.

FIG. 5 illustrates a schematic diagram of a twelve conductors per group encoding 500 according to embodiments of the disclosure. In this embodiment, encoding produces one group A of all of the twelve conductors in the group. This embodiment provides for 924 unique code words (e.g., data elements that may be represented by the different combinations of balanced signals that are to be transmitted across the conductors). In this encoding, each group may have 924 different balanced combinations and as there is 1 groups, 924¹=924 code words (e.g., unique combinations). The equivalent number of conductors for a parallel electrical connection to transmit 924 code words without the encoding disclosed herein is log₂ 924=9.85 conductors (e.g., pins). Thus the conductor (e.g., pin) efficiency is the number of conductors for a parallel electrical connection without encoding (9.85) divided by the number of pins used with the encoding of this embodiment (12), i.e.,

$$\frac{9.85}{12} = 0.82$$

conductor efficiency. This data is also shown in Table 1 below.

TABLE 1

| | | | Equivalent Bits | Conductor |
|---|---|---|---|---|
| | Conductors per | Code Words | without | (Pin) |
| FIG. | Group | with Encoding | Encoding | Efficiency |
| 2 | 2 | 64 | 6 | 0.50 |
| 3 | 4 | 216 | 7.8 | 0.65 |
| 4 | 6 | 400 | 8.64 | 0.72 |
| 5 | 12 | 924 | 9.85 | 0.82 |

In one embodiment, conductor efficiency may be maximized. In one embodiment, each code word represents a (e.g., unique) combination of information, for example, such that more combinations of code words allow a higher bandwidth (e.g., either data signal group or command address signal group) for the conductors to transmit information. In one embodiment, each code word represents a (e.g., unique) request or command (e.g., a load or a store). In one embodiment of double data rate (DDR) synchronous dynamic random-access memory (SDRAM) architecture, a byte of data without the encoding disclosed herein may be transmitted by 8 data signal (DQ) conductors (e.g., wires), 2 data strobe signal (DQS) conductors, and 1 data masking signal (DM) conductor for 11 conductors (e.g., wires) in total. Certain embodiments herein may utilize 12 conductors (e.g., 1 added to the 11 conductors to form a byte of data without the balanced transmission encoding discussed herein). Other balanced encoding schemes may be utilized according to this disclosure, e.g., for a specific application.

The conductors are illustrated as extending longitudinally in the same plane in FIGS. 2-5. In another embodiment, one or more conductors (e.g., in a group) may be grouped together (e.g., in an equally distributed manner), for example, extending longitudinally along the periphery of a circle, square, rectangle, or other polygon. The conductors may be spaced adjacent to one or more other conductors, e.g., less than about one or two diameters of a conductor apart. The depicted conductors have a circular cross-sectional profile, although others (e.g., a square or a rectangle) may be utilized.

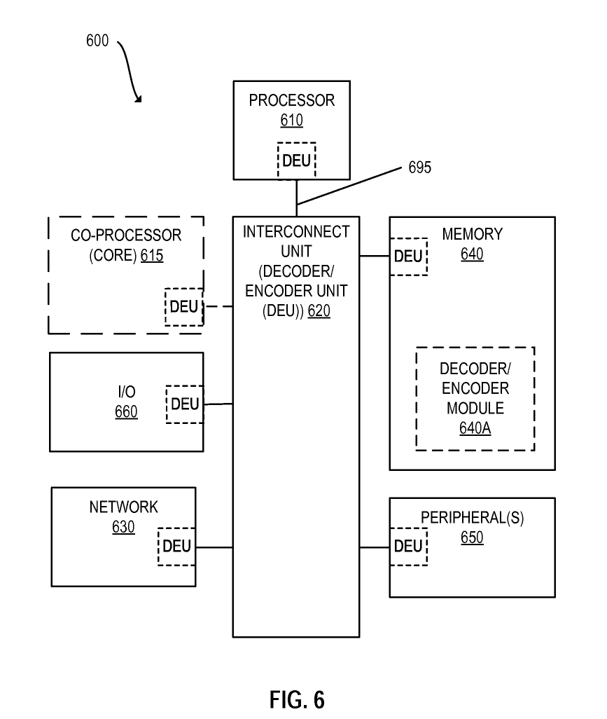

Referring now to FIG. 6, shown is a block diagram of a system 600 according to embodiments of the disclosure. The system (e.g., any, multiple, or all components thereof) may be a single system-on-a-chip (SoC). Any component may transmit data to one or more of the other components according to this disclosure. A component may transmit data with a built-in or separate encoder to a built-in or separate decoder of one of more other components, e.g., via an electrical connection (e.g., conductor) therebetween. Although certain interconnects (e.g., 695) are depicted in FIG. 6, any component (depicted or not) to communicate with another component may utilize an electrical connection with the balanced transmission encoding discussed herein. For example, processor 610 may communicate with co-processor (e.g., core) 615 via a conductor extending directly therebetween (not depicted). Each depicted component in FIG. 6 includes an optional decoder and encoder unit (DEU). In one embodiment, a DEU includes only a decoder or only an encoder. In one embodiment, a DEU includes a decoder and an encoder, e.g., to transmit and received data. In one embodiment, a DEU is not utilized for each component and a single, centralized decoder and encoder unit may perform any encoding and/or decoding. In one embodiment, a decoder is optional.

System 600 may include one or more processors (or cores) 610, 615, which are coupled to an electrical connection unit (e.g., having parallel conductors). In FIG. 6, the electrical connection unit is an interconnect unit 620. In one embodiment, the interconnect unit 620 includes controller hub(s) for one or more components. In one embodiment, the interconnect unit 620 may include conductors, for example, and an encoder connected (e.g., in series) to a component that is to transmit data across the conductors. Interconnect unit 620 may connect memory 640, co-processor 615, peripheral(s) 650, network 630 (e.g., internet), and/or input/output (I/O) 660 devices. In one embodiment, peripheral 650 is an application-specific integrated circuit (ASIC) and/or a field-programmable gate array (FPGA). Additionally or alternatively, one or both of memory and graphics controllers may be integrated within the processor. Memory 640 and/or the co-processor 615 may be connected directly to the processor 610. Memory 640 may include a decoder/encoder module 640A, for example, to store code that when executed causes a processor to perform any method of this disclosure. Each processor 610, 615 may include one or more processing cores. The memory 640 may be, for example, dynamic random access memory (DRAM), phase change memory (PCM), or a combination of the two. In one embodiment, the interconnect unit 620 communicates with the processor(s) 610, 615 via a multi-drop bus, such as a frontside bus (FSB), point-to-point interface (e.g., QuickPath Interconnect (QPI)), or other conductor 695. In one embodiment, the processor(s) 610, 615 executes instructions that control data processing operations of a general type, e.g., to cause the balanced transmission encoding and/or decoding discussed herein. In certain embodiments, the balanced transmission encoding and/or decoding discussed herein may be utilized with memory interface (i/f), on-package I/O (OPIO), universal peripheral interface (UPI), Ethernet, Peripheral Component Interconnect express (PCIe), Universal Serial Bus (USB), display, and/or wireless links, e.g., a relay-link (r-link), data transmission.

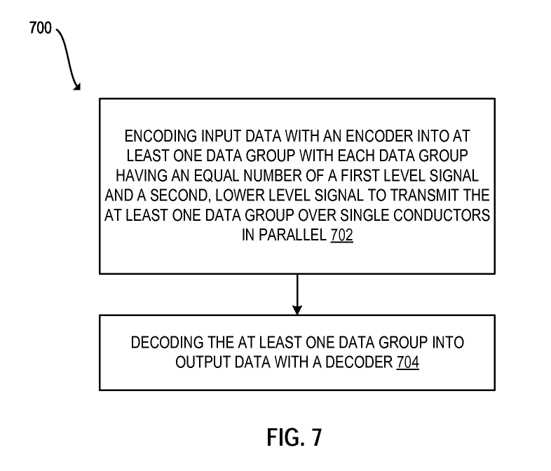

FIG. 7 illustrates a flow diagram 700 according to embodiments of the disclosure. Depicted flow 700 includes encoding input data with an encoder into at least one data group with each data group having an equal number of a first level signal and a second, lower level signal to transmit the at least one data group over single conductors in parallel 702, and decoding the at least one data group into output data with a decoder 704.

In certain embodiments, a balanced encoding scheme causes the net di/dt for a conductor group or a set of conductor groups to be at or about zero at any given time (e.g., to the first order), for example, to minimize any (power delivery) simultaneous switch noise (SSN). In certain embodiments, a balanced encoding scheme may reduce crosstalk noise, for example, where the encoded data patterns (e.g., code words) are a (e.g., small) subset of all possible data patterns without encoding. In certain embodiments, a balanced, 2-level signaling (e.g., in contrast to 4-level signaling) encoding scheme may allow usage of existing circuits and/or use less power and die area. In certain embodiments, a balanced, single ended encoding scheme may have a performance advantage over non-balanced, single ended signaling, e.g., with both partial discharge (PD) and crosstalk impacts considered. In certain embodiments, a balanced encoding scheme may be used on (e.g., high speed) memory I/O and other I/O interfaces for computing components. In one embodiment, a balanced, single ended encoding scheme may replace a differential interface.

In one embodiment, an apparatus includes an encoder to encode input data into at least one data group with each data group having an equal number of a first level signal and a second, lower level signal to transmit the at least one data group over single conductors in parallel, and a decoder to decode the at least one data group into output data. The first level signal may be a positive voltage and the second, lower level signal may be a negative voltage. The positive voltage and the negative voltage may be equal and opposite voltages. The first level signal may be a positive voltage and the second, lower level signal may be about zero volts. Each single conductor may include a (e.g., its own) transmitter on a first end and a receiver (e.g., its own) on a second, opposing end. For example, such that each conductor may be powered (e.g., to send a signal) separately from the other conductors. The at least one data group may be a plurality of data groups. The input data may be a byte. Each single conductor may be a conductor of a twelve conductor parallel bus.

In another embodiment, a method includes encoding input data with an encoder into at least one data group with each data group having an equal number of a first level signal and a second, lower level signal to transmit the at least one data group over single conductors in parallel, and decoding the at least one data group into output data with a decoder. The encoding may include providing the first level signal as a positive voltage and the second, lower level signal as a negative voltage. The positive voltage and the negative voltage may be equal and opposite voltages. The encoding may include providing the first level signal as a positive voltage and the second, lower level signal at about zero volts. Each single conductor may include a (e.g., its own) transmitter on a first end and a receiver (e.g., its own) on a second, opposing end. The at least one data group may be a plurality of data groups. The input data may be a byte. Each single conductor may be a conductor of a twelve conductor parallel bus.

In yet another embodiment, a system includes a processor comprising an encoder to encode input data into at least one data group with each data group having an equal number of a first level signal and a second, lower level signal to transmit the at least one data group over single conductors in parallel, and a hardware component comprising a decoder to decode the at least one data group into output data. The hardware component may be memory. The hardware component may be an application-specific integrated circuit. The first level signal may be a positive voltage and the second, lower level signal may be a negative voltage. The positive voltage and the negative voltage may be equal and opposite voltages. The first level signal may be a positive voltage and the second, lower level signal may be about zero volts. Each single conductor may include a (e.g., its own) transmitter on a first end and a receiver (e.g., its own) on a second, opposing end. The at least one data group may be a plurality of data groups. The input data may be a byte. Each single conductor may be a conductor of a twelve conductor parallel bus.

In another embodiment, an apparatus includes means to encode input data into at least one data group with each data group having an equal number of a first level signal and a second, lower level signal to transmit the at least one data group over single conductors in parallel, and means to decode the at least one data group into output data.

In yet another embodiment, an apparatus comprises a data storage device that stores code that when executed by a hardware processor causes the hardware processor to perform any method disclosed herein. An apparatus may be as described in the detailed description. A method may be as described in the detailed description.

Embodiments (e.g., of the mechanisms) disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code may be executed to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. The mechanisms described herein are not limited in scope to any particular programming language. The language may be a compiled or interpreted language.

One or more aspects of at least one embodiment may be implemented by representative instructions stored on a non-transitory, machine-readable medium which represents various logic within the processor, which when read by a machine causes the machine to fabricate logic to perform the techniques described herein. Such representations, which may be generally referred to as “IP cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

What is claimed is:

1. An apparatus comprising:
an encoder to encode input data into at least one data group with each data group having an equal number of a first level signal and a second, lower level signal to transmit the at least one data group over single conductors in parallel; and
a decoder to decode the at least one data group into output data.

2. The apparatus of claim 1, wherein the first level signal is a positive voltage and the second, lower level signal is a negative voltage.

3. The apparatus of claim 2, wherein the positive voltage and the negative voltage are equal and opposite voltages.

4. The apparatus of claim 1, wherein the first level signal is a positive voltage and the second, lower level signal is about zero volts.

5. The apparatus of claim 1, wherein each single conductor comprises a transmitter on a first end and a receiver on a second, opposing end.

6. The apparatus of claim 1, wherein the at least one data group is a plurality of data groups.

7. The apparatus of claim 1, wherein the input data is a byte and each single conductor is a conductor of a twelve conductor parallel bus.

8. A method comprising:
encoding input data with an encoder into at least one data group with each data group having an equal number of a first level signal and a second, lower level signal to transmit the at least one data group over single conductors in parallel; and
decoding the at least one data group into output data with a decoder.

9. The method of claim 8, wherein the encoding comprises providing the first level signal as a positive voltage and the second, lower level signal as a negative voltage.

10. The method of claim 9, wherein the positive voltage and the negative voltage are equal and opposite voltages.

11. The method of claim 8, wherein the encoding comprises providing the first level signal as a positive voltage and the second, lower level signal at about zero volts.

12. The method of claim 8, wherein each single conductor comprises a transmitter on a first end and a receiver on a second, opposing end.

13. The method of claim 8, wherein the at least one data group is a plurality of data groups.

14. The method of claim 8, wherein the input data is a byte and each single conductor is a conductor of a twelve conductor parallel bus.

15. A system comprising:
a processor comprising an encoder to encode input data into at least one data group with each data group having an equal number of a first level signal and a second, lower level signal to transmit the at least one data group over single conductors in parallel; and
a hardware component comprising a decoder to decode the at least one data group into output data.

16. The system of claim 15, wherein the hardware component is memory.

17. The system of claim 15, wherein the hardware component is an application-specific integrated circuit.

18. The system of claim 15, wherein the first level signal is a positive voltage and the second, lower level signal is a negative voltage.

19. The system of claim 18, wherein the positive voltage and the negative voltage are equal and opposite voltages.

20. The system of claim 15, wherein the first level signal is a positive voltage and the second, lower level signal is about zero volts.

21. The system of claim 15, wherein each single conductor comprises a transmitter on a first end and a receiver on a second, opposing end.

22. The system of claim 15, wherein the at least one data group is a plurality of data groups.

23. The system of claim 15, wherein the input data is a byte and each single conductor is a conductor of a twelve conductor parallel bus.
